(19) United States
(12) Patent Application Publication
(10) Pub. No.: US 2005/0216335 A1
(43) Pub. Date: Sep. 29, 2005

(54) System and method for providing on-line user-assisted Web-based advertising

(76) Inventors: Andrew Fikes, Los Altos, CA (US); Ovidiu Predescu, Santa Clara, CA (US); Mike Frumkin, Santa Cruz, CA (US)

Correspondence Address: Kulpreet Rana;Google Inc., 1600 Amphitheatre Parkway, Building 41, Mountain View, CA, 94043, US

(21) Appl. No.: 10/808,993

(22) Filed: Mar. 24, 2004

(51) Int. Cl. G06F 17/60

(52) U.S. Cl. 705/14

(57) ABSTRACT

A system and method for providing on-line advertising is presented. An interface guiding on-line advertising creation is presented. An advertisement is created from at least one of user inputs and stored data and includes information describing at least one item. An advertising creative is generated in association with the advertisement and includes a hyperlink reference to the advertisement. The advertisement is hosted on-line as a Web page and the advertising creative is placed on one or more targeted Web pages.

### FIELD OF THE INVENTION

The invention relates in general to Web-based advertising and, in particular, to a system and method for providing on-line user-assisted Web-based advertising.

### BACKGROUND OF THE INVENTION

Although the origins of the Internet trace back to the late 1960s, the more recently-developed Worldwide Web (“Web”) has revolutionized accessibility to untold volumes of information in stored electronic form. In particular, the Web provides an attractive opportunity to individual advertisers and businesses who wish to reach a potentially large audience at low cost.

Effective on-line advertising through the Web requires some form of notice or announcement describing a product or service offering in a manner analogous to television, radio and printed media. On the Web, advertisements can be provided as Web pages, which can also contain hyperlinks to a virtual shopping cart, email addresses, and other helpful information. However, Web-based advertisements, or simply, advertisements, must also be coupled with means to drive Web traffic via the advertisement. One approach to driving Web traffic is provided through the placement of advertising creatives on other Web pages, such as results generated by search engines, Web pages targeted by advertising engines, and general Web content. A typical advertising creative, or simply, “creative,” is a description of a product or service potentially containing text, images and other content that can be added to an existing Web page and that will direct a user to a Web page.

Web-based advertising poses a unique set of challenges, particularly with respect to individual advertisers. First, generating successful advertising creatives that effectively drive Web traffic requires significant time, effort and expertise. The Web is primarily a printed medium and creatives must often fit within limited display space, which can be difficult for novice advertisers to achieve while still providing essential content. Moreover, providing salient and relevant creatives can be challenging, particularly when a creative is displayed with other competing creatives and unrelated but distracting Web content.

Web-based advertisements are only effective if made available to a target pool of potential buyers. Web advertising can be targeted or tied to Web content by attaching creatives, such as described in commonly-assigned U.S. patent application Ser. No. 10/676,195, entitled “System and Method for Automatically Targeting Web-Based Advertisements,” filed Sep. 30, 2003, pending, the disclosure of which is incorporated by reference. In most cases, however, the individual advertiser must generally specify selection criteria, frequently by providing a set of keywords for use in targeting, which will hopefully attract potential buyers. Users can also find the selection of keywords challenging. For example, searching for Web content using a query containing the search term “mouse” can generate documents describing tiny long-tailed rodents, cartoon characters, and computer pointing devices.

Placing creatives and advertisements on-line for access by the general Web community can be especially problematic for individual or small advertisers. Advertising creatives must be integrated into other Web content to effectively drive Web traffic, but advertisers are generally not able to unilaterally add creatives to other Web pages. A third party Web content provider, such as a search or advertising engine, is needed. Small advertisers may not have an online Web presence, and, therefore, traditional Web advertising that drives Web traffic to the Web site of the advertiser is not possible.

Therefore, there is a need for an approach to providing Web-based user-assisted advertising. Preferably, such an approach would guide a user in the creation of advertisements describing offerings of goods or services, creatives associated with the advertisements, and advertising budgets. Such an approach would also help create and host a Web presence for individual and other advertisers. Such an approach would also facilitate driving Web traffic to hyperlinked advertisements through targeting.

### SUMMARY OF THE INVENTION

An embodiment provides a system and method for providing on-line advertising. An interface guiding on-line advertising creation is presented. An advertisement is created from at least one of user inputs and stored data and includes information describing at least one item. An advertising creative is generated in association with the advertisement and includes a hyperlink reference to the advertisement. The advertisement is hosted on-line as a Web page and the advertising creative is placed on one or more targeted Web pages. In a further embodiment, an advertising budget specifying compensation for on-line display of the advertising creative is determined.

Still other embodiments of the invention will become readily apparent to those skilled in the art from the following detailed description, wherein are described embodiments of the invention by way of illustrating the best mode contemplated for carrying out the invention. As will be realized, the invention is capable of other and different embodiments and its several details are capable of modifications in various obvious respects, all without departing from the spirit and the scope of the invention. Accordingly, the drawings and detailed description are to be regarded as illustrative in nature and not as restrictive.

### BRIEF DESCRIPTION OF THE DRAWINGS

FIG. 1 is a block diagram showing a system for providing on-line user-assisted Web-based advertising, in accordance with the invention.

FIG. 2 is a process flow diagram showing the operations followed to create Web-based advertising according to one embodiment of the invention.

FIGS. 3A-F are screen shots showing, by way of example, Web pages providing on-line user-assisted Web-based advertising.

FIG. 4 is a functional block diagram showing a user-assisted advertising generation engine, in accordance with one embodiment.

FIG. 5 is a functional block diagram showing an advertising server, in accordance with one embodiment.

FIG. 6 is a flow diagram showing a method for providing on-line user-assisted Web-based advertising, in accordance with one embodiment.

FIG. 7 is a flow diagram showing the routine for guiding a user for use in the method of FIG. 6.

FIG. 8 is a flow diagram showing the routine for creating an advertisement for use in the routine of FIG. 7.

FIG. 9 is a flow diagram showing the routine for generating an advertising creative for use in the routine of FIG. 7.

FIG. 10 is a flow diagram showing the routine for specifying an advertising budget for use in the routine of FIG. 7.

### DETAILED DESCRIPTION

System Overview

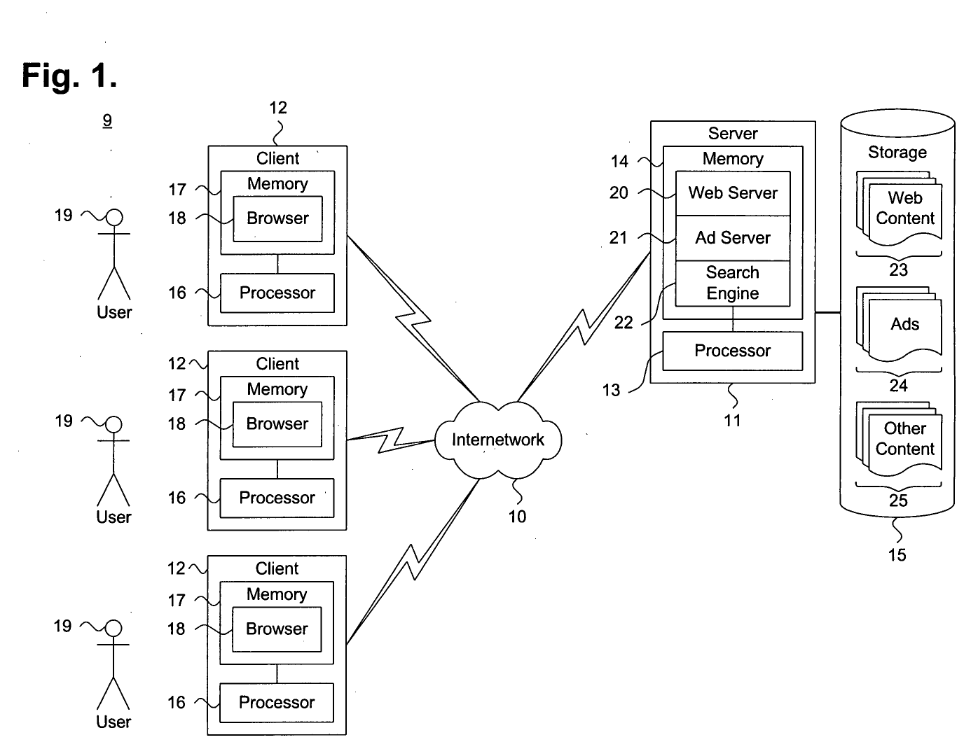

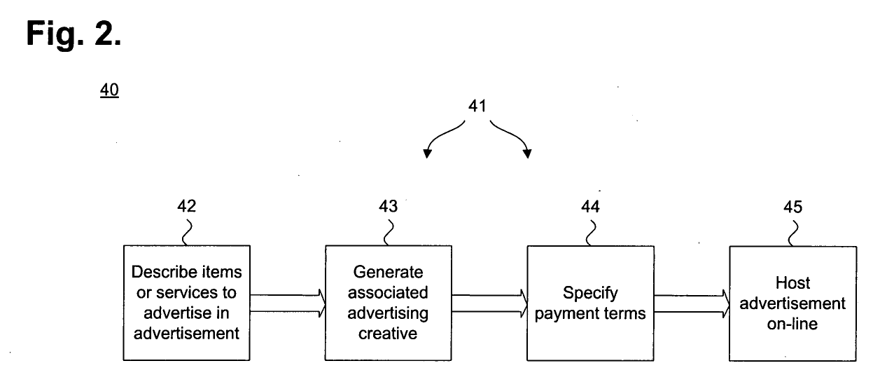

FIG. 1 is a block diagram showing a system 9 for providing on-line user-assisted Web-based advertising, in accordance with the invention. A plurality of individual client computers 12 are communicatively interfaced to a server 11 via an internetwork 10, such as the Internet, or other form of communications network, as will be appreciated by one skilled in the art. The individual client computers 12 are operated by users 19 who transact requests for Web content, advertisements, other types of content, and other operations through their respective client computer 12, as well as placing Web-based advertisements, as further described below beginning with reference to FIG. 2.

Each client computer 12 can be any form of computing platform connectable to a network, such as the internetwork 10, and capable of interacting with application programs. Examples of individual clients include, without limitation, personal computers, digital assistants, “smart” cellular telephones and pagers, lightweight clients, workstations, “dumb” terminals interfaced to an application server, and various arrangements and configurations thereof, as will be appreciated by one skilled in the art. The internetwork 10 includes various topologies, configurations, and arrangements of network interconnectivity components arranged to interoperatively couple with enterprise, wide area and local area networks and include, without limitation, conventionally wired, wireless, satellite, optical, and equivalent network technologies, as will be appreciated by one skilled in the art.

For Web content retrieval, each client computer 12 executes a Web browser 18 (“Browser”). Web content 23 is requested via a Web server 20 executing on the server 11. In addition, advertisements (“Ads”) 24 can be provided with the Web content 23, and other content 25 via an advertisement server (“Ad Server”) 21 also executing on the server 11. The advertisement server 21 can target the advertisements 24 for inclusion with or in lieu of the Web content 23, and other content 25, such as described in commonly-assigned U.S. patent application Ser. No. 10/676,195, entitled “System and Method for Automatically Targeting Web-Based Advertisements,” filed Sep. 30, 2003, pending, the disclosure of which is incorporated by reference. Other types of server functionality can be provided, as will be appreciated by one skilled in the art. Note the Web browsing and advertising functions could also be implemented separately as stand alone applications.

The server 11 maintains an attached storage device 15 in which the Web content 23, advertisements 24, and other content 25 are stored. The Web content 23, advertisements 24, and other content 25 could also be maintained remotely on other Web servers (not shown) interconnected either directly or indirectly via the internetwork 10 and which are preferably accessible by each client computer 12.

A search engine 22 executes on the server 11 for processing queries for Web content 23, advertisements 24, and other content 25. Each query is meant to describe or otherwise identify information potentially retrievable via the Web server 20. The information can include other information also determined to be relevant to the query. In one embodiment, each query provides characteristics, typically expressed as terms, including individual words and compounds. The search engine 22 receives a query, identifies matching Web content 23, advertisements 24, and other content 25, and sends back results conforming to the query preferences. Other styles, forms or definitions of queries, query characteristics, and related metadata are feasible, as will be appreciated by one skilled in the art.

In one embodiment, the search engine 22 identifies the Web content 23, advertisements 24, and other content 25 determined to be highly relevant in relation to a given set of search query terms, for example, using such techniques as described in S. Brin and L. Page, “The Anatomy of a Large-Scale Hypertextual Search Engine” (1998) and in U.S. Pat. No. 6,285,999, issued Sep. 4, 2001 to Page, the disclosures of which are incorporated by reference. In identifying matching Web content 23, advertisements 24, and other content 25, the search engine 22 operates on information characteristics describing potentially retrievable content. Note the functionality provided by the server 20, including the Web server 20, advertising server 21, and search engine 22, could be provided by a loosely- or tightly-coupled distributed or parallelized computing configuration, in addition to a uniprocessing environment.

The individual computer systems, including server 11 and client computers 12, include general purpose, programmed digital computing devices including a central processing unit (processors 13 and 16, respectively), random access memory (memories 14 and 17, respectively), non-volatile secondary storage 15, such as a hard drive or CD ROM drive, network or wireless interfaces, and peripheral devices, including user interfacing means, such as a keyboard and display. Program code, including software programs, and data is loaded into the RAM for execution and processing by the CPU and results are generated for display, output, transmittal, or storage.

Process Flow

FIG. 2 is a process flow diagram 40 showing the operations 41 followed to create Web-based advertising according to one embodiment of the invention. A Web page is created that contains an advertisement describing the items or services that are the subject of the advertisement (operation 42). Although in one embodiment, the created Web page is described as containing an advertisement, in other embodiments of the invention, the Web page need not include an “advertisement” and may contain other content, such as, for example information or content associated with the advertiser or the products and services offered by the advertiser. An advertising creative is generated (operation 43). Payment terms can be specified for the displaying of the advertising creative (operation 44). The advertisement and the creative are hosted on-line (operation 45). Each operation 41 can either be performed directly by the user 19 or through automated means, such as with pre-filled data fields, user histories and default preference settings. Pre-filled data fields include, for instance, data stored using cookie-based favorites. In addition, the advertising budget can be created at any point following one or more of creating the advertisement, generating the advertising creative, and publication.

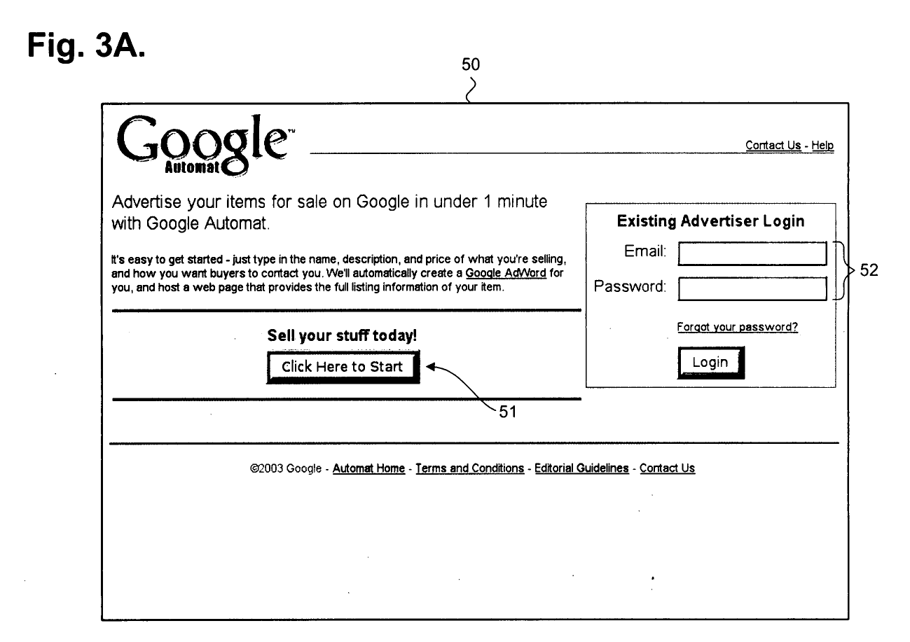

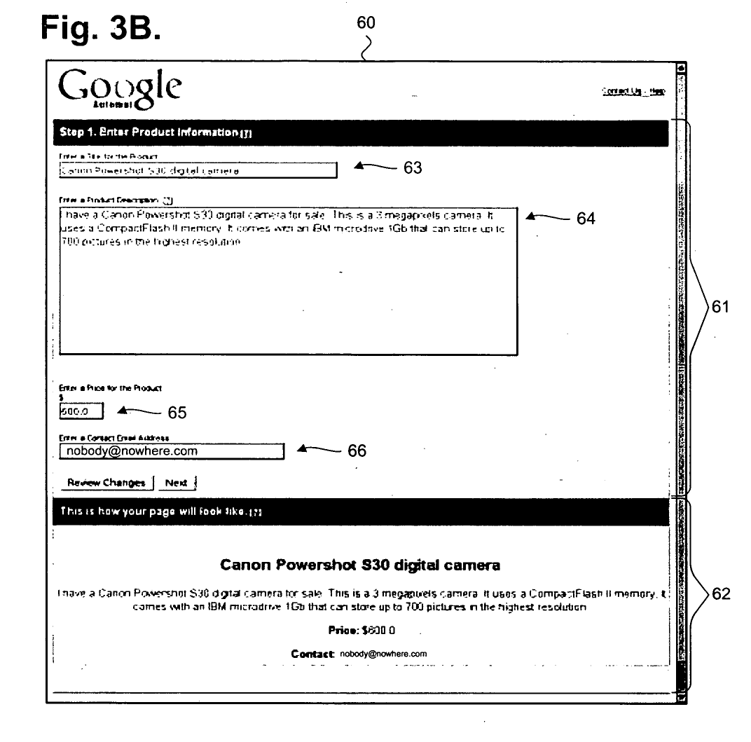

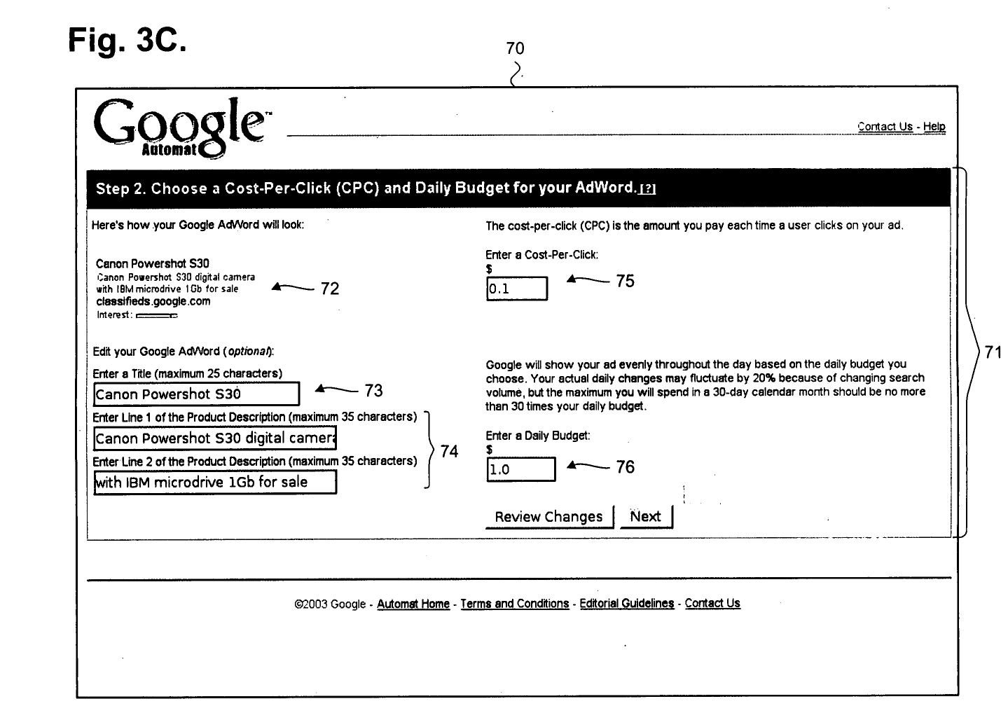

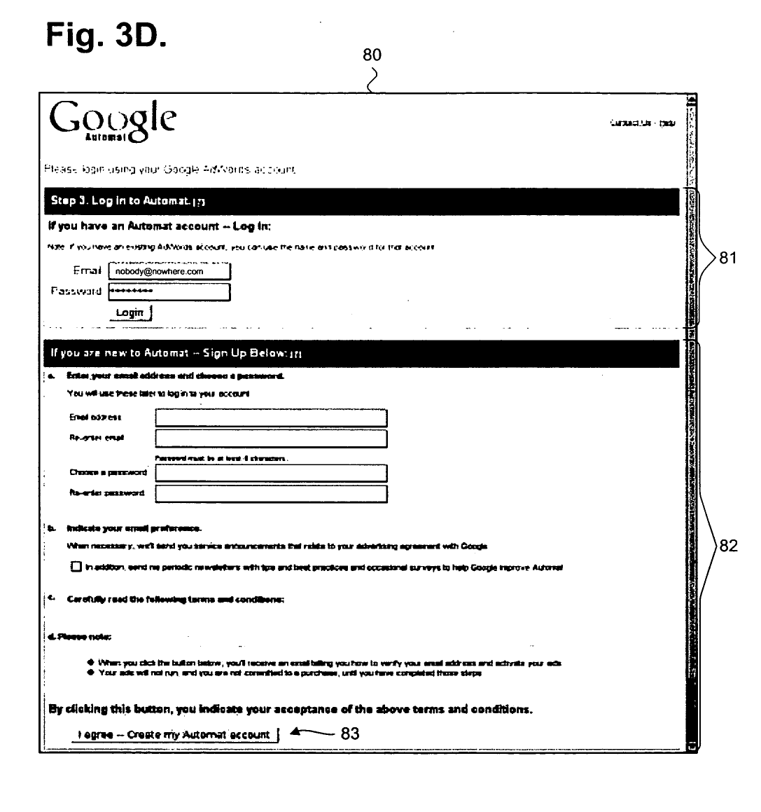

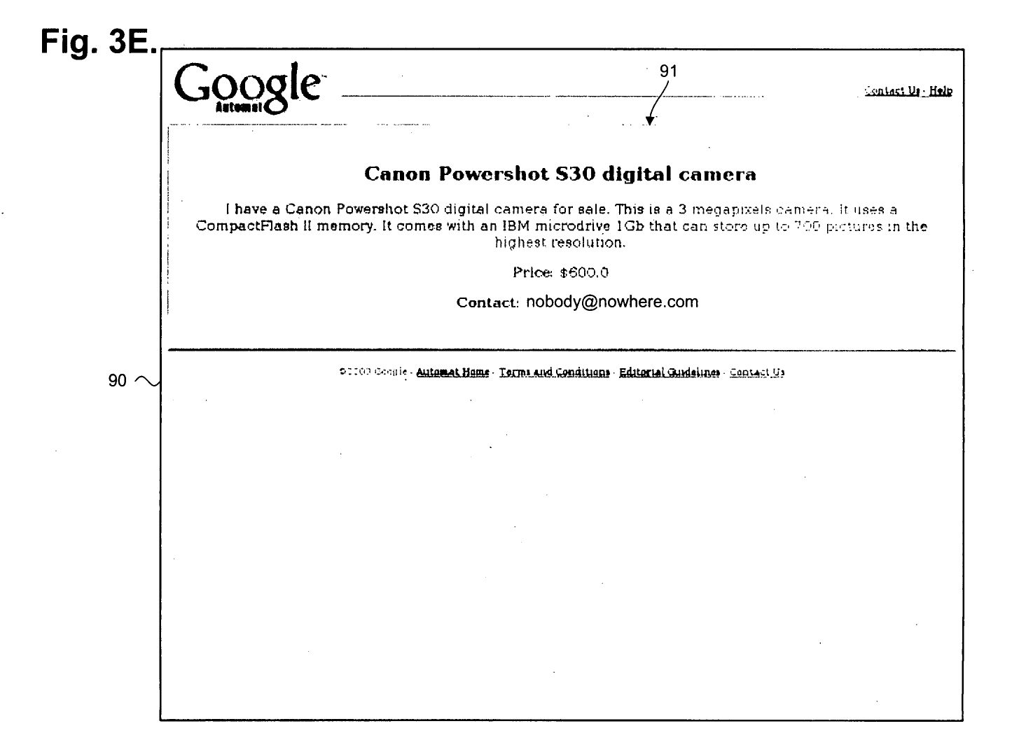

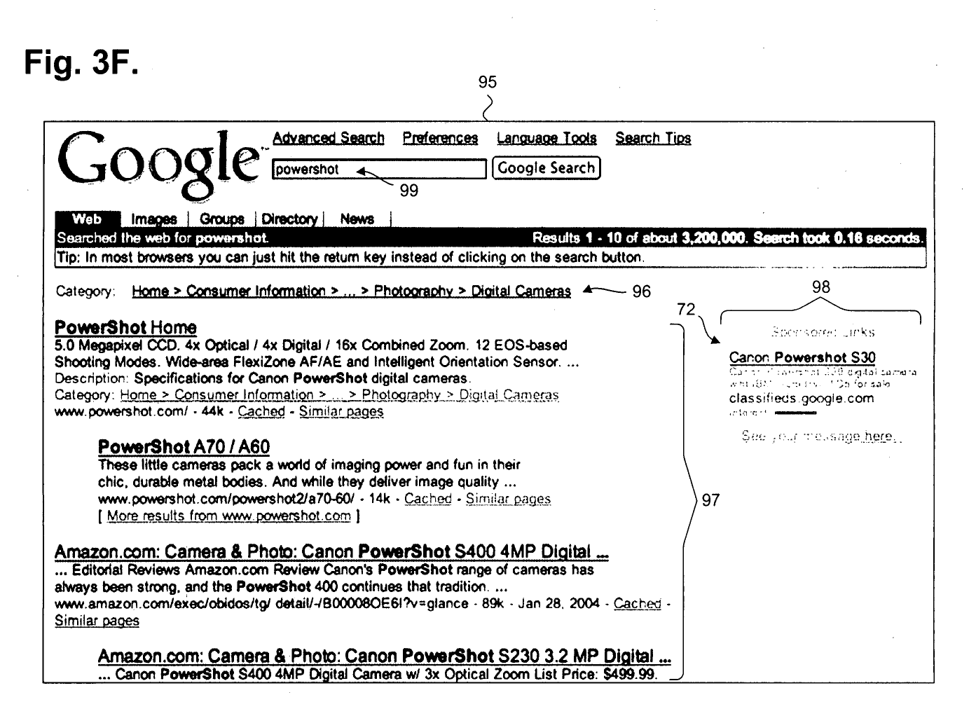

In certain embodiments, each operation 41 is presented to the user 19 through a Web interface. FIGS. 3A-E are screen shots showing, by way of example, Web pages providing on-line user-assisted Web-based advertising according to an embodiment of the invention. Referring first to FIG. 3A, in one embodiment, a screen shot 50 of a Web page showing a login to a series of Web pages providing guided user-assisted advertising is provided. The login is optional but provides a convenient starting point in generating advertising. In the described embodiment, statistics for all items currently being advertised for sale are listed upon successfully completing a login. The login enables a new user to proceed through the operations 41 by either selecting the button 51 or by logging in as an existing advertiser through a login prompt 52.

Referring next to FIG. 3B, a screen shot 60 showing a Web page for entering product information is provided. Through a product information screen 61, the item to be advertised, such as by sale, license, lease or other disposition, is described (operation 42). Alternatively, a service or combination of goods and service could be described. The user can provide a title 63, product description 64, price 65, and contact email address 66, although not all of the information fields need to be specified and other information could also be requested, either in lieu of or in addition to the foregoing information. A mockup advertisement screen 62 displays the advertisement generated as a Web page. In a further embodiment, the user can provide a reference to a directly-accessible stored item description from which suitable content can be extracted. In a still further embodiment, the user can provide a hyperlink to an indirectly-accessible stored item description from which suitable content can be extracted.

Referring next to FIG. 3C, a screen shot 70 showing a Web page for generating an advertising creative 72 and for specifying an advertising budget is provided. Prior to entry into a budget specification screen 71, the advertising creative 72 is generated and displayed (operation 43). In certain embodiments, the creative 72 is automatically generated based on the product information provided in operation 42. Thereafter, the user can edit the advertising creative 72 by providing a title 73 and product description 74, although not all of the information fields need to be specified and other information could also be requested, either in lieu of or in addition to the foregoing information. The user can also provide the payment terms (operation 44). The payment terms define the payment arrangements between the user that is placing the advertisement and the third party advertiser that will host the advertising creative 72 on-line. Payment terms may include, for example, paying the third party advertiser on a per impression or per click basis 75, based on Web traffic, or by conversion, based on a percentage or fixed commission of the selling price. For per impression or per click payment models, a daily budget 76 can also be specified. Other forms of advertising budgets and payment and advertising referral and compensation arrangements are possible.

Referring next to FIG. 3D, a screen shot 80 showing a Web page for formalizing the publication of the advertisement and creative is provided. Through a logon screen 81, the user logs in and implicitly authorizes the on-line publication of the advertisement and creative (operation 45). Alternatively, if the user is new, through a signup screen 82, the user enters identification and acceptance information to authorize the on-line publication of the advertisement and creative. In one embodiment, the advertisement is hosted if the user 19 does not have a Web presence for serving the advertisement as a Web page. Other information (not shown in FIG. 3D) may also be provided by the user or advertiser, such as name, address, age, credit card information, and so forth.

Referring next to FIG. 3E, a screen shot 90 showing a Web page displaying advertisement 91 is provided. In this embodiment, the hosted web page is an advertisement 91 that provides the user-specified description of the item being advertised. A separate advertising creative 72 (not shown in FIG. 3E) is displayed separately on Web pages served by a Web server 20 or targeted by an advertising server 21 to drive Web traffic to the advertisement 91. Depending upon the payment terms, the service provider operating the advertising server 21 may collect compensation for the displaying of the advertising creative in accordance with the payment terms.

In other embodiments of the invention, the hosted Web page is not restricted to, and indeed does not necessarily contain, an advertisement of a form, such as described with reference to FIG. 3E. Instead, for example, the landing Web page for the advertising creative 72, that is, the Web page to which the advertising creative 72 links, may be a conventional product Web page that describes the product or service offered for sale in more detail. The landing Web page may also be a Web page on a Web site operated by the advertiser, in which case, the service provider would not need to provide hosting services for the advertiser. The landing Web page may also offer additional functionality, such as allowing a visitor to complete a purchase by logically clicking on appropriate buttons or links. Thus, the landing Web page may be a shopping Web page, and the service provider may host a store for the advertiser and offer functionality typically offered in such online stores, such as shopping cart, secure login, account management, credit card acceptance and payment processing, and so forth. Such functionality is well known to those of ordinary skill in the art, and therefore in the interests of clarity, are not further described herein.

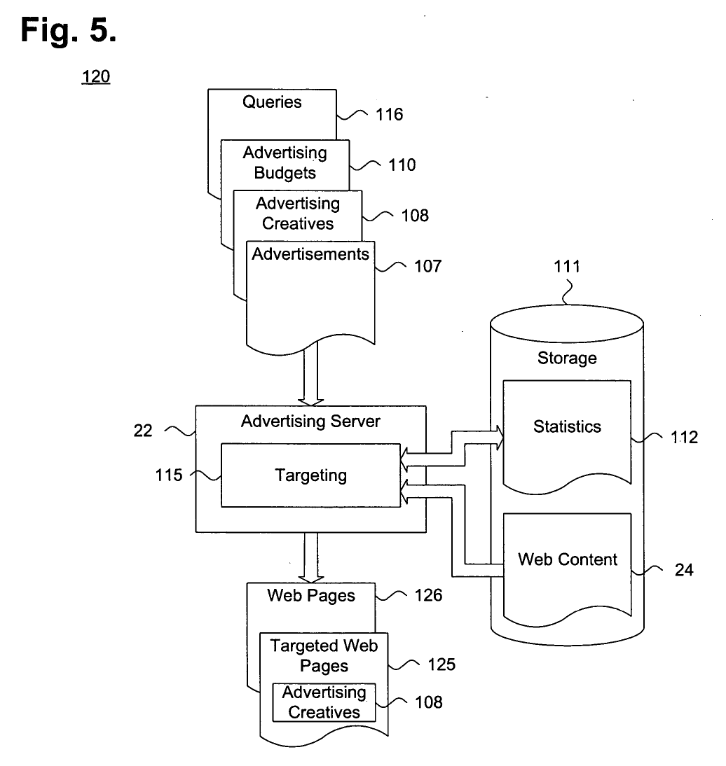

Referring finally to FIG. 3F, a screen shot 95 showing the advertising creative 72 associated with the advertisement or landing Web page 91 is provided. The advertising creative 72 may be provided as part of a set of sponsored links 98, which are included on a Web page containing a set of search results 97 generated by a search engine 22 (shown in FIG. 1). By way of example, the search results 97 are generated in response to the execution of a query 99 containing the search term “powershot,” although other forms of specifying a query or search criteria are possible. The advertising server 21 (shown in FIG. 5) can target the advertising creative 72 and the sponsored links 98 for inclusion on the Web page by matching the search terms in the query 99 to the advertisement 91, such as described in commonly-assigned U.S. patent application Ser. No. 10/676,195, entitled “System and Method for Automatically Targeting Web-Based Advertisements,” filed Sep. 30, 2003, pending, the disclosure of which is incorporated by reference. In a further embodiment, a category 96 most closely relating to the search results 97 is also provided. Note that according to one aspect of the invention, the advertiser need not specify targeting information, such as keywords, to trigger the delivery of the advertising creative 72 to users; instead, the targeting may be performed automatically based on product, service or other information entered by the advertiser or other stored information.

Advertising Generation Engine

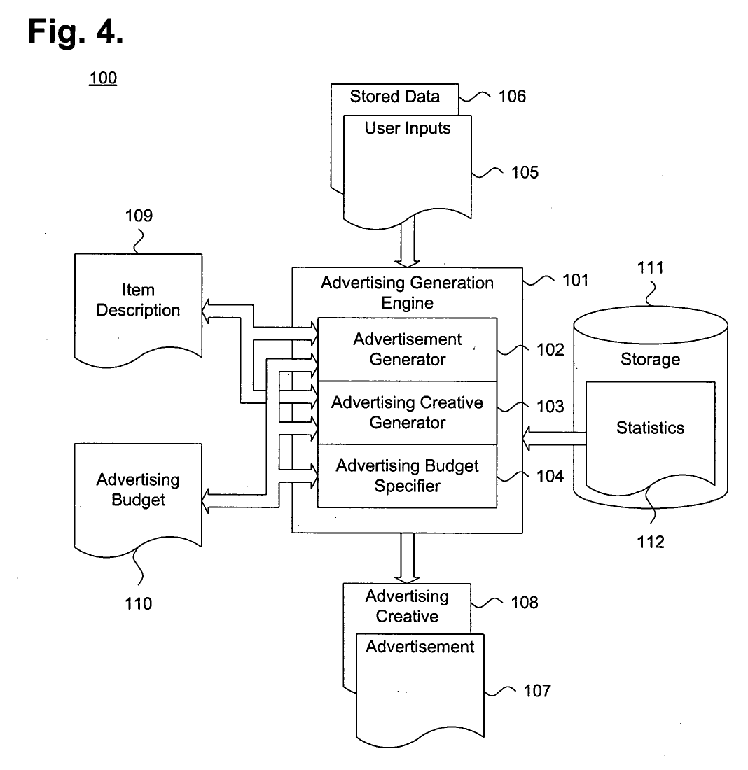

FIG. 4 is a functional block diagram 50 showing a user-assisted advertising generation engine 101, in accordance with one embodiment. The advertising generation engine 101 provides an interface to guide on-line advertising creation, which may include an advertisement 107 and an associated advertising creative 108. The advertising generation engine 101 can also host the advertisement 107 or other information associated with the advertiser or the offered products or services, or even an on-line store, as described above, on-line as a Web page.

The advertising generation engine 101 maintains a connection to a storage device 111 storing statistics 112. In one embodiment, performance statistics 112 are generated by the advertising server 21, search engine 22 for existing on-line advertisements 24. The advertising generation engine 101 provides the statistics 112 to the user for consideration while building an advertisement 107 and advertising creative 107. Other types of information relating to on-line advertising could also be maintained in the storage 111.

Briefly, the advertising generation engine 101 assists a user 19 in building an advertisement 107 and an advertising creative 108 based on user inputs 105 or, optionally, stored data 106. The advertising generation engine 101 can also assist a user 19 in specifying an advertising budget 110. The advertising generation engine 101 includes an advertisement generator 102, advertising creative generator 103, and advertising budget specifier 104. The advertisement generator 102 collects and assembles user inputs 105 and, optionally, stored data 106, for use in generating advertisements 107, which are provided as Web pages 90 (shown in FIG. 3E), and advertising creatives 108. The user inputs 105 are manually provided by the user 19 through the Web browser 18 or other interfacing means. In addition, the user inputs 60 can be supplemented by pre-filled data fields. The stored data 59 can include other Web content, advertisements, and other persistently stored content, including the Web content 23, advertisements 24, and other content 25 stored by the server 11 (shown in FIG. 1), as well as files, databases, documents, and excerpts from other sources. The advertisement generator 102 can store the user inputs 105 and, if applicable, stored data 106, in an item description 109, which can also store characteristics about the item being advertised.

Similarly, the creative generator 103 collects and assembles additional user inputs 105 and, optionally, stored data 106, to generate advertising creatives 108. The creative generator 103 can also use the item description 109 specified by the advertisement generator 102 as a basis for advertising creatives 108. In a further embodiment, advertising creatives are automatically generated from structured data, including the item description 109, such as described in commonly-assigned U.S. patent application Ser. No. 10/725,883, entitled “System and Method for Providing Text Summarization for Use in Web-Based Content,” filed Dec. 1, 2003, pending, the disclosure of which is incorporated by reference.

Finally, the advertising budget specifier 104 creates an advertising budget 110, which is used by the advertising engine 21 when displaying the advertising creative 108. The advertising budget specifier 104 collects and assembles additional user inputs 105 and, optionally, stored data 106, to determine the advertising budget 110.

The advertisement generator 102 builds an advertisement 107 as a Web page using a predefined Web-based format. The advertisement generator 102 also generates one or more advertising creatives 108 as Web content that can be added to a Web page. Each advertisement 107 can include an item name and a body containing an extended item name, description, price, category name, advertiser contact information, or other content. Each advertising creative 108 is associated with the advertisement 107 and can include information extracted from or related to the item description 109, as well as other information, such as an eye-catching image, that might assist in driving Web traffic to the associated advertisement 107.

In one embodiment, each advertisement 107 is provided as Web content written in a suitable variant of a hypertext markup language, such as the Hypertext Markup Language (HTML). Although described with reference to product offerings, the advertisement 107 can also be used to describe service or combined product and service offerings. Thus, the terms “product” and “service” are considered interchangeable and, except as expressly provided otherwise, apply equally to either or both product and service offerings.

The individual computer system, including the advertising generation engine 101, include general purpose, programmed digital computing devices including a central processing unit, random access memory, non-volatile secondary storage 61, such as a hard drive or CD ROM drive, network or wireless interfaces, and peripheral devices, including user interfacing means, such as a keyboard and display. Program code, including software programs, and data is loaded into the RAM for execution and processing by the CPU and results are generated for display, output, transmittal, or storage.

Advertising Server

FIG. 5 is a functional block diagram 120 showing an advertising server 21, in accordance with one embodiment. The advertising server 21 logically places advertising creatives 107 associated with advertisements 107 on targeted Web pages 125. Briefly, the advertising server 21 places advertising creatives 108 on the targeted Web pages 125 for an advertiser based on a specified advertising budget 110. Targeted Web pages 125 include search result pages or third party Web pages that can be identified through advertising content targeting, as further described below.

The advertising server 21 maintains a connection to the storage device 111 storing statistics 112 and, optionally, the Web content 23. The statistics 112 are generated by the advertising server 21 or search engine 22 (not shown) for existing on-line advertisements 24. The advertising server 21 provides the statistics 112 to the advertiser for consideration while creating an advertisement 107 and advertising creative 107. In one embodiment, the statistics 112 reflect the frequency that an advertising creative 108 is shown to and selected by users. Other statistics and types of information relating to on-line advertising could also be maintained in the storage 111.

The advertising server 21 includes a targeting component 115 that identifies, that is, targets, advertisements 107 relative to the query 116. In one embodiment, the identified advertisements 107 are scored preferably according to the degree of match between the terms in the query and the information and characteristics specified in the identified advertisements 107, such as described in commonly-assigned U.S. patent application Ser. No. 10/676,195, entitled “System and Method for Automatically Targeting Web-Based Advertisements,” filed Sep. 30, 2003, pending, the disclosure of which is incorporated by reference. A numerical score can be assigned to the identified advertisements 107 based on the degree of match and the identified advertisements 107 can be ranked by numerical score. The advertising server 21 then provides one or more of the advertising creatives 108 associated with the selected and ranked advertisements 107 as Web content included on targeted Web pages 125. The advertising server 21 can also pass non-targeted Web pages 126 through without the addition of advertising creatives 108. Other forms of targeting of advertisements 107, as well as introduction of advertising creatives 108, are possible, as would be appreciated by one skilled in the art.

Method Overview

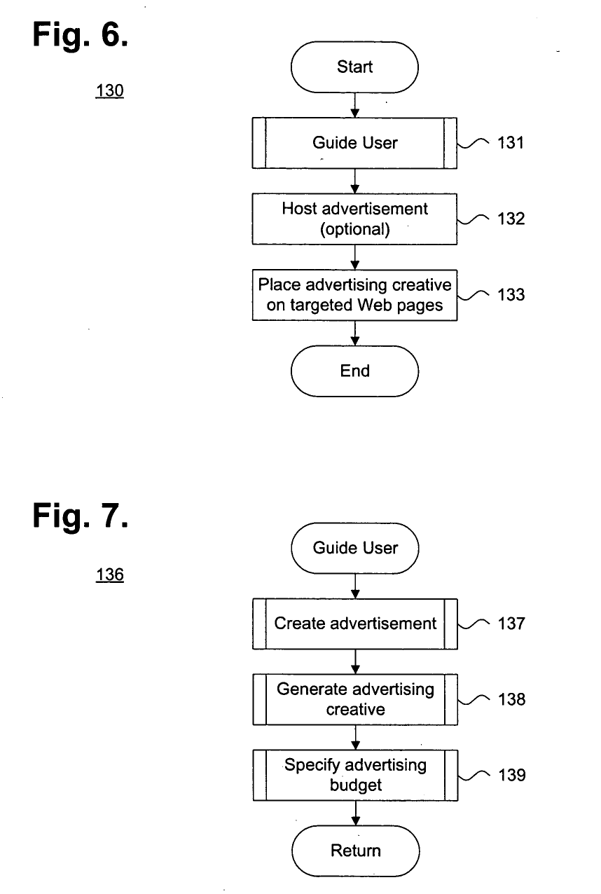

FIG. 6 is a flow diagram showing a method 130 for providing on-line user-assisted Web-based advertising, in accordance with one embodiment. The method 130 is described as a sequence of process operations or steps, which can be executed, for instance, by the advertising generation engine 101, advertising server 21, or other components.

First, a user 19 is guided through creating an advertisement 107 and an associated creative 108, plus an advertising budget 110 (block 131), as further described below with reference to FIG. 7. Optionally, the advertisement 107 can be hosted on a Web page (block 132) by a third party advertiser if the user 19 does not have a Web presence. Finally, the advertisement 107 is targeted to facilitate driving Web traffic by placing the associated advertising creative 108 on targeted Web pages 125 (block 133), such as described in commonly-assigned U.S. patent application Ser. No. 10/676,195, entitled “System and Method for Automatically Targeting Web-Based Advertisements,” filed Sep. 30, 2003, pending, the disclosure of which is incorporated by reference. The routine then terminates.

User Guiding Routine

FIG. 7 is a flow diagram showing the routine 136 for guiding a user 19 for use in the method 130 of FIG. 6. One purpose of the routine is to guide a user in the creation of an advertisement 107 describing an offering of goods or services, a creative 108 associated with the advertisement 107, and an advertising budget 110.

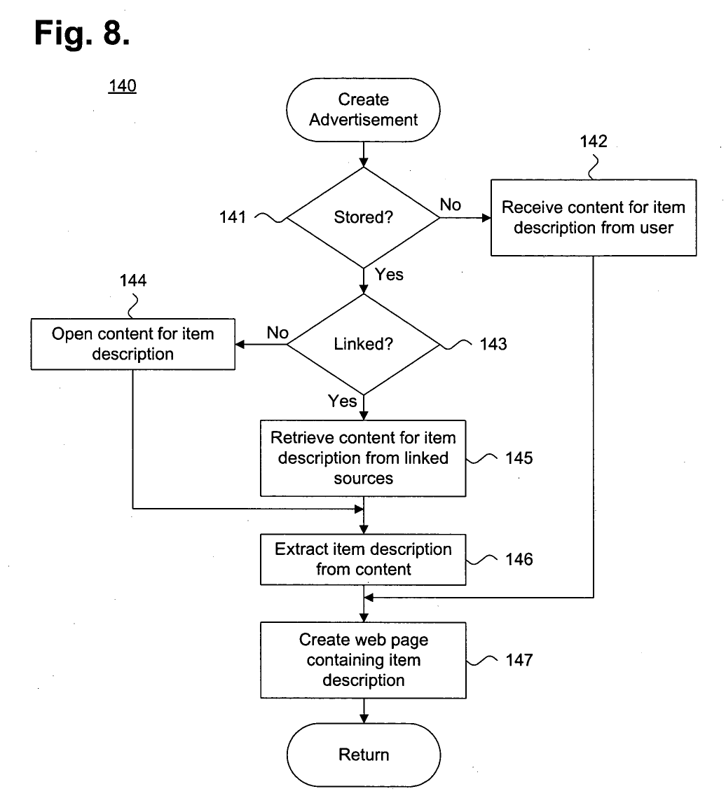

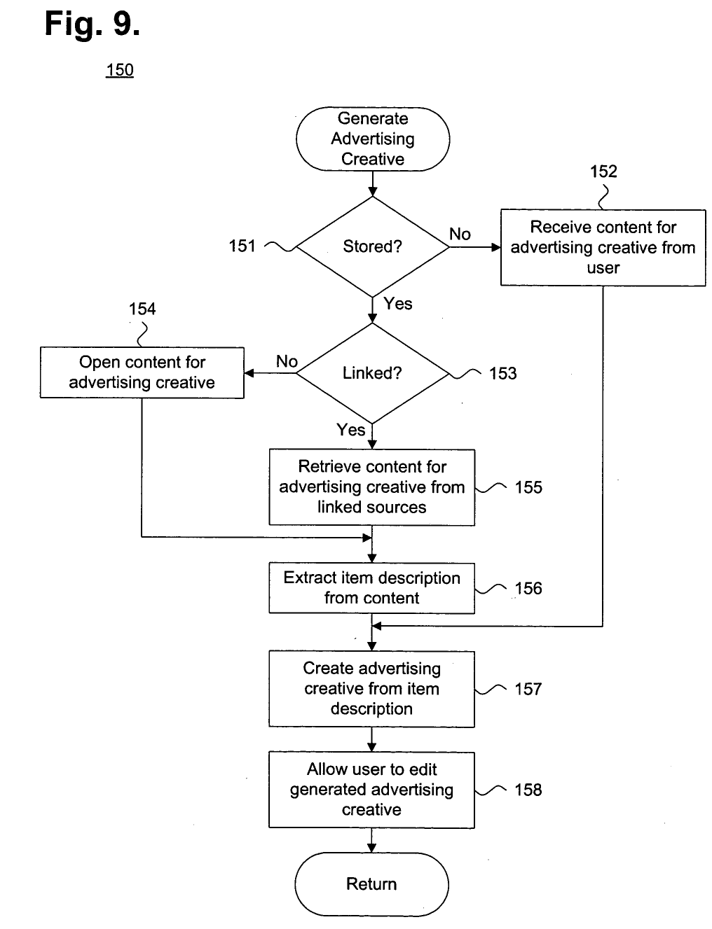

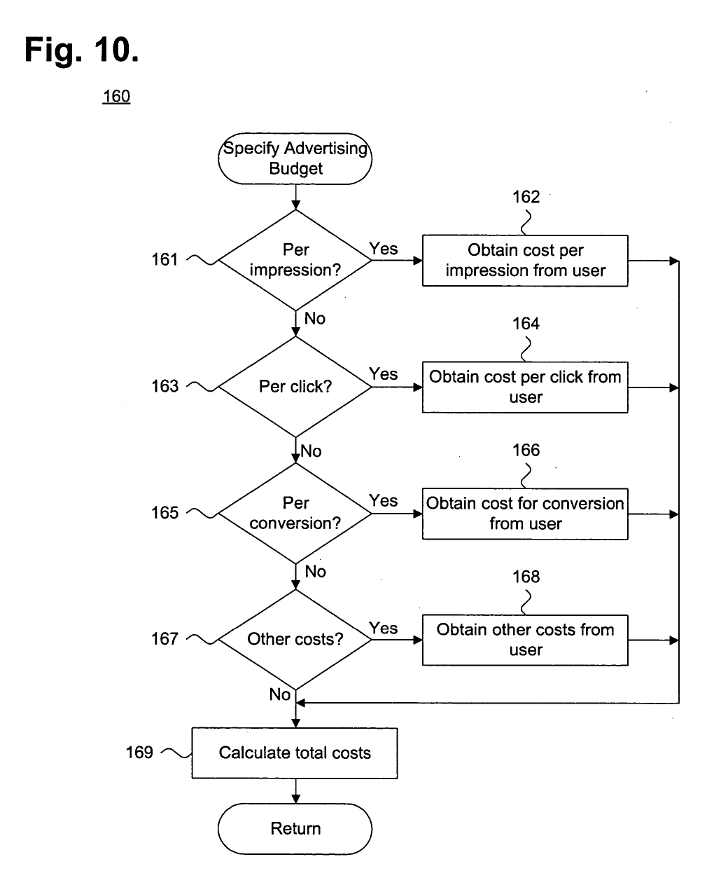

First, an item to be advertised in an advertisement 107 for goods or services is described (block 137), as further described below with reference to FIG. 8. Next, an advertising creative 108 is generated (block 138), as further described below with reference to FIG. 9. Finally, a selling budget 110 is specified (block 137), as further described below with reference to FIG. 10. The routine then returns.

Advertisement Creation Routine

FIG. 8 is a flow diagram showing the routine 140 for creating an advertisement 107 for use in the routine 136 of FIG. 7. One purpose of the routine is to build an item description 109 for use in the advertisement 107.

If the item description 109 is based on user inputs 105 (block 141), the user inputs 105 are received (block 142) as the item description 109 from the user 19, such as through a product information screen 61 (shown in FIG. 3B). Otherwise, if the item description 109 is based on stored information (block 141), which is directly accessible, that is, is persistently stored as stored data 106 (block 143), the stored data 106 is opened as the item description 109 (block 144). If the item information 109 is based on stored information (block 141), which is indirectly accessible, that is, is provided as a hyperlinked Web page (block 143), the hyperlinked Web page is retrieved as the item description 109 (block 145). If necessary, the item description 109 is extracted (block 146), such as described in commonly-assigned U.S. patent application Ser. No. 60/507,617, entitled “Systems and Methods for Information Extraction,” filed Sep. 30, 2003, pending, the disclosure of which is incorporated by reference. Finally, a Web page containing the item description 109 is created as the advertisement 107 (block 147). The routine then returns.

Advertising Creative Generation Routine

FIG. 9 is a flow diagram showing the routine 150 for generating an advertising creative 108 for use in the routine 136 of FIG. 7. One purpose of the routine is to generate an advertising creative 108.

In one embodiment, the advertising creative 108 can be automatically generated from the item description 109, such as described in commonly-assigned U.S. patent application Ser. No. 10/725,883, entitled “System and Method for Providing Text Summarization for Use in Web-Based Content,” filed Dec. 1, 2003, pending, the disclosure of which is incorporated by reference. Otherwise, if the advertising creative 108 is based on user inputs 105 (block 151), the user inputs 105 are received (block 152) as the advertising creative 108 from the user 19, such as through a budget specification screen 71 (shown in FIG. 3C). Otherwise, if the advertising creative 108 is based on stored information (block 151), which is directly accessible, that is, is persistently stored as stored data 106 (block 153), the stored data 106 is opened as the advertising creative 108 (block 154). Finally, if the item information 109 is based on stored information (block 151), which is indirectly accessible, that is, is provided as a hyperlinked Web page (block 153), the hyperlinked Web page is retrieved as the advertising creative 108 (block 155). If necessary, the item description 109 is extracted (block 146), such as described in commonly-assigned U.S. patent application Ser. No. 60/507,617, entitled “Systems and Methods for Information Extraction,” filed Sep. 30, 2003, pending, the disclosure of which is incorporated by reference. Web content containing the advertising creative 108 is created from the item description 109 (block 157). Finally, the user 19 can optionally edit the advertising creative 108 (block 158). The routine then returns.

Advertising Budget Specification Routine

FIG. 10 is a flow diagram showing the routine 160 for specifying an advertising budget 110 for use in the routine 136 of FIG. 7. One purpose of this routine is to specify the payment arrangements between the user 19 and the third party advertiser. Advertising budgets include, for example, paying the third party advertiser on a per impression or per click basis, based on Web traffic, or by conversion, based on a percentage or fixed commission of the selling price. Other forms of advertising budgets are possible.

Thus, if the user 19 indicates a cost charged per impression through an advertising budget specification interface 92 (block 161), the cost per impression 97 is obtained (block 162). Similarly, if the user 19 indicates a cost charged per click (block 163), the cost per click 99 is obtained (block 164). If the user 19 indicates a cost charged by conversion (block 165), the cost by conversion 101 is obtained (block 166). If the user 19 indicates a cost charged per some other type of cost (block 167), the cost is obtained (block 168). The total costs chargeable to the user 19 are calculated (block 169) and the routine returns.

While the invention has been particularly shown and described as referenced to the embodiments thereof, those skilled in the art will understand that the foregoing and other changes in form and detail may be made therein without departing from the spirit and scope of the invention.

1. A system for providing on-line advertising, comprising:
an advertising generation engine to present an interface guiding on-line advertising creation, comprising:
an advertisement interface to create an advertisement from at least one of user inputs and stored data and comprising information describing at least one item; and
an advertising creative interface to generate an advertising creative in association with the advertisement and including a hyperlink reference to the advertisement; and
an advertising engine to host the advertisement on-line as a Web page and to place the advertising creative on one or more targeted Web pages.

2. A system according to claim 1, further comprising:
an indexer to identify one or more advertisements relevant to a query, wherein the identified advertisements describe characteristics relevant to at least one item;
a scorer to score the advertisements based on match between the query and the characteristics of the identified advertisements; and
a targeting component to provide the advertising creative associated with at least one such advertisement as Web-based content.

3. A system according to claim 2, wherein a numerical score is assigned to the identified advertisements based on a degree of the match, and at least some of the identified advertisements are ranked by the numerical score.

4. A system according to claim 2, wherein at least some of the advertisements are provided as the Web-based content in response to selection of the hyperlink reference of the associated advertising creative.

5. A system according to claim 2, wherein the advertising creative is targeted by associating one or more query terms with the item description.

6. A system according to claim 1, wherein at least part of the information is included in the advertising creative.

7. A system according to claim 1, further comprising:
an advertising creative generator to automatically generate the advertising creative from the information.

8. A system according to claim 1, further comprising:
an advertising budget interface to determine an advertising budget specifying compensation associated with the advertising creative.

9. A system according to claim 8, wherein the advertising budget includes a budgeted compensation amount per unit of time.

10. A system according to claim 8, wherein compensation is collected for on-line publication of the advertising creative in accordance with the advertising budget.

11. A system according to claim 8, wherein the advertising budget is based on at least one of per impression of the formatted advertisement, per click of the formatted advertisement and by a conversion of the at least one item.

12. A system according to claim 1, wherein the item description comprises at least one of text, an image, price, contact information, and payment information.

13. A system according to claim 1, wherein the stored data comprises at least one of persistently-stored data and a hyperlinked Web page.

14. A method for providing on-line advertising, comprising:
presenting an interface guiding on-line advertising creation, comprising:
creating an advertisement from at least one of user inputs and stored data and comprising information describing at least one item; and
generating an advertising creative in association with the advertisement and including a hyperlink reference to the advertisement; and
hosting the advertisement on-line as a Web page and placing the advertising creative on one or more targeted Web pages.

15. A method according to claim 14, further comprising:
identifying one or more advertisements relevant to a query, wherein the identified advertisements describe characteristics relevant to at least one item;
scoring the advertisements based on match between the query and the characteristics of the identified advertisements; and
providing the advertising creative associated with at least one such advertisement as Web-based content.

16. A method according to claim 15, further comprising:
assigning a numerical score to the identified advertisements based on a degree of the match; and
ranking at least some of the identified advertisements by the numerical score.

17. A method according to claim 15, further comprising:
providing at least some of the advertisements as the Web-based content in response to selection of the hyperlink reference of the associated advertising creative.

18. A method according to claim 15, further comprising:
targeting the advertising creative by associating one or more query terms with the item description.

19. A method according to claim 14, further comprising:
including at least part of the information in the advertising creative.

20. A method according to claim 14, further comprising:
automatically generating the advertising creative from the information.

21. A method according to claim 14, further comprising:
determining an advertising budget specifying compensation associated with the advertising creative.

22. A method according to claim 21, wherein the advertising budget includes a budgeted compensation amount per unit of time.

23. A method according to claim 21, further comprising:
collecting compensation for on-line publication of the advertising creative in accordance with the advertising budget.

24. A method according to claim 21, wherein the advertising budget is based on at least one of per impression of the formatted advertisement, per click of the formatted advertisement and by a conversion of the at least one item.

25. A method according to claim 14, wherein the item description comprises at least one of text, an image, price, contact information, and payment information.

26. A method according to claim 14, wherein the stored data comprises at least one of persistently-stored data and a hyperlinked Web page.

27. A computer-readable storage medium holding code for performing the method according to claim 14.

28. An apparatus for providing on-line advertising, comprising:
means for presenting an interface guiding on-line advertising creation, comprising:
means for creating an advertisement from at least one of user inputs and stored data and comprising information describing at least one item; and
means for generating an advertising creative in association with the advertisement and means for including a hyperlink reference to the advertisement; and
means for hosting the advertisement on-line as a Web page and means for placing the advertising creative on one or more targeted Web pages.
